(19) United States
(12) Patent Application Publication
(10) Pub. No.: US 2017/0094174 A1
(43) Pub. Date: Mar. 30, 2017

(54) IMAGING DEVICE

(71) Applicant: NIDEC SANKYO CORPORATION, Suwa-gun (JP)

(72) Inventors: Shinroku ASAKAWA, Suwa-gun (JP); Mitsuo YOKOZAWA, Suwa-gun (JP)

(21) Appl. No.: 15/275,822

(22) Filed: Sep. 26, 2016

(30) Foreign Application Priority Data
Sep. 29, 2015 (JP) 2015-190558

(51) Int. Cl. H04N 5/232

(52) U.S. Cl. CPC H04N 5/23287; H04N 5/23258; H04N 5/2329

(57) ABSTRACT

An imaging device may include a movable body having an optical unit, a support body structured to turnably support the movable body around an axial line of an optical axis of the optical unit or around an axial line parallel to the optical axis, and a turning drive mechanism structured to turn the movable body around the axial line. The support body includes a fixing face for fixing the support body to a moving body in a direction perpendicular the axial line.

### CROSS REFERENCE TO RELATED APPLICATION

The present invention claims priority under 35 U.S.C. §119 to Japanese Application No. 2015-190558 filed Sep. 29, 2015, the entire content of which is incorporated herein by reference.

### FIELD OF THE INVENTION

At least an embodiment of the present invention may relate to an imaging device which is capable of correcting a shake around an optical axis.

### BACKGROUND

In an imaging device which is installed in a running vehicle or the like (hereinafter, referred to as a “moving body”), when scenery is imaged while running, it is desirable that a horizontal line in a photographed image is horizontally projected regardless of a posture of the moving body. Therefore, a technique has been proposed in which, even in a case that a moving body is inclined when the moving body runs an inclined ground, an imaging device installed in the moving body is set in a horizontal state by cancelling the inclination (see, for example, Japanese Patent Laid-Open No. 2007-142993). In the technique described in the Patent Literature, a pole is installed in the moving body (vehicle device) so as to be capable of inclining and a camera is set at an upper end of the pole. The pole is inclined in an opposite direction to the inclined direction of the moving body by an inclination angle of the moving body which is detected by an inclination detecting part installed in the moving body and thereby the inclination angle of the moving body is canceled and the camera is held horizontally.

However, in the technique described in the above-mentioned Patent Literature, for example, when the pole itself is inclined by centrifugal force (acceleration) acted during cornering, the inclination angle of the moving body is not canceled and the camera is unable to be held horizontally.

### SUMMARY

In view of the problem described above, at least an embodiment of the present invention may advantageously provide an imaging device which is capable of correcting inclination around the optical axis of an optical unit caused by acceleration and the like.

According to at least an embodiment of the present invention, there may be provided an imaging device including a movable body having an optical unit for imaging, a support body structured to turnably support the movable body around an axial line of an optical axis of the optical unit or around an axial line parallel to the optical axis, and a turning drive mechanism structured to turn the movable body around the axial line. The support body includes a fixing face for fixing the support body to a moving body in a direction perpendicular the axial line.

In at least an embodiment of the present invention, when the imaging device is fixed to a moving body such as a vehicle through a fixing face of the support body, the optical unit is supported by the moving body in a state that the optical axis is directed toward a horizontal direction. In this state, when the moving body is inclined so that the optical unit is inclined around the optical axis, the turning drive mechanism turns the movable body around the axial line based on a detected result by an inertial sensor provided in the support body of the imaging device or provided in the moving body to correct the inclination around the optical axis of the movable body. Therefore, even when the optical unit is inclined around the optical axis due to acceleration (centrifugal force) when the moving body is inclined, the inclination around the optical axis of the optical unit is capable of being corrected. Accordingly, the optical unit is capable of capturing images in an appropriate posture.

In at least an embodiment of the present invention, the imaging device includes an inertial sensor configured to detect inclination around the axial line in the moving body and the turning drive mechanism turns the movable body around the axial line based on a detected result of the inertial sensor. In other words, a motor provided in the turning drive mechanism turns the movable body around the axial line based on a detected result of the inertial sensor configured to detect inclination around the axial line in the moving body. According to this structure, when a moving body is inclined, inclination around the axial line in the moving body is detected by the imaging device and the movable body is turned around the axial line by an amount of the inclination and thereby influence due to the inclination of the moving body can be corrected. In at least an embodiment of the present invention, the inertial sensor is held by the support body. In at least an embodiment of the present invention, the inertial sensor is held by the moving body. In at least an embodiment of the present invention, the inertial sensor detects angular velocity when the moving body is inclined and acceleration applied to the moving body. According to this structure, both of inclination of the moving body which does not include acceleration and the inclination of the moving body due to the acceleration can be corrected.

In at least an embodiment of the present invention, a drive source of the turning drive mechanism is a motor, and the fixing face is located between the optical unit and the motor in an extending direction of the axial line. According to this structure, the fixing face is provided between the optical unit and a drive source (motor) each of which has relatively heavy weight and thus the imaging device can be fixed to the moving body in a well-balanced manner. Therefore, the imaging device can be restrained from swinging by an external force.

In at least an embodiment of the present invention, the movable body includes a circuit board between the optical unit and the motor in the extending direction of the axial line, and a dimension in the extending direction of the axial line of the movable body is longer than a dimension in a direction perpendicular the axial line. According to this structure, the size in a direction perpendicular to the optical axis of the imaging device can be reduced.

In at least an embodiment of the present invention, a gravity center of the movable body is located at a position overlapping with the fixing face in the extending direction of the axial line. According to this structure, the imaging device can be fixed to the moving body in a well-balanced manner. Therefore, the imaging device can be restrained from swinging by an external force.

In at least an embodiment of the present invention, the motor is held by the support body, one side end part in the extending direction of the axial line of the support body is provided with a first turning support part which turnably supports the movable body, and the other side end part in the extending direction of the axial line of the support body is provided with a second turning support part which turnably supports the movable body. According to this structure, the support body is capable of supporting the movable body in a stable state at two positions in the extending direction of the axial line. Specifically, it may be structured that the one side end part in the extending direction of the axial line of the support body is formed with a first turning support plate part formed in a direction perpendicular to the extending direction of the axial line, the first turning support part is provided in the first turning support plate part, the other side end part in the extending direction of the axial line of the support body is formed with a second turning support plate part formed in a direction perpendicular to the extending direction of the axial line, and the second turning support part and the motor are held by the second turning support plate part. In this case, it may be structured that the movable body includes a case which accommodates the optical unit and the circuit board, the movable body is turnably supported by the first turning support part provided in the first support plate part between the optical unit and the circuit board, the circuit board is disposed between the first turning support part and the second turning support part, the second turning support part is provided with a gear which is driven by the motor, and the movable body is turned by the gear.

In at least an embodiment of the present invention, a gravity center of the movable body is located to a lower side in a gravity direction of the axial line. According to this structure, when acceleration is not acted on the optical unit, the movable body is set in a hanged state in a vertical direction by an own weight of the movable body and thus the optical unit is set in a posture that its optical axis is directed to a horizontal direction.

In at least an embodiment of the present invention, a gravity center of the movable body is located at the same position in a gravity direction as the axial line. According to this structure, even when acceleration in a horizontal direction is acted on the imaging device, a swing is hard to be occurred in the movable body.

In at least an embodiment of the present invention, the axial line is extended so as to pass a lens of the optical unit. According to this structure, a space for turning the movable body for correcting inclination around the optical axis of the optical unit can be reduced.

In at least an embodiment of the present invention, the support body surrounds the movable body in three directions perpendicular to the axial line through a space, and a turnable range around the axial line of the movable body is restricted by an interference of the movable body with the support body when the movable body is turned around the axial line. According to this structure, excessive inclination of the movable body can be prevented.

In at least an embodiment of the present invention, the turnable range around the axial line of the movable body is set to be 30° or more to both sides around the axial line from a state that the turning drive mechanism is not driven. According to this structure, inclination of the optical unit due to inclination during movement of a moving body such as a vehicle can be corrected effectively.

In at least an embodiment of the present invention, the optical unit includes a photographing module having a lens and an imaging element, and a swing drive mechanism structured to swing the photographing module around two axial lines intersecting the optical axis. According to this structure, inclination around two axial lines of the optical unit due to inclination during movement of a moving body such as a vehicle can be corrected.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIGS. 1A and 1B are perspective views showing an imaging device in accordance with an embodiment of the present invention.

FIGS. 2A and 2B are “Y-Z” cross-sectional views showing an imaging device in accordance with an embodiment of the present invention.

FIG. 3 is an “X-Y” cross-sectional view showing an imaging device in accordance with an embodiment of the present invention.

FIG. 4 is an exploded perspective view showing an imaging device in accordance with an embodiment of the present invention.

FIGS. 5A and 5B are explanatory views showing turning support parts of an imaging device in accordance with an embodiment of the present invention.

FIGS. 6A and 6B are explanatory views showing a control system for rolling correction in an imaging device in accordance with an embodiment of the present invention.

FIG. 7 is an exploded perspective view showing an optical unit of an imaging device in accordance with an embodiment of the present invention.

### DETAILED DESCRIPTION

An embodiment of the present invention will be described below with reference to the accompanying drawings. In the following description, three directions perpendicular to each other are referred to as an “X” direction, a “Y” direction and a “Z” direction, and a direction along an optical axis “L” (optical axis of a lens/optical axis of an optical element) is set to be the “Z” direction. A direction perpendicular to the “Z” direction is the “Y” direction and a direction intersecting the “Z” direction and the “Y” direction is the “X” direction. Further, in the following description, regarding swings in the respective directions, turning around the “Z”-axis corresponds to rolling, turning around the “X”-axis corresponds to pitching (vertical swing), and turning around the “Y”-axis corresponds to yawing (lateral swing). Further, “X1” is indicated on one side of the “X” direction, “X2” is indicated on the other side, “Yl” is indicated on one side of the “Y” direction, “Y2” is indicated on the other side, “Z1” is indicated on one side (object side/front side in the optical direction) of the “Z” direction, and “Z2” is indicated on the other side (opposite side to an object side/rear side in the optical direction).

An imaging device 100 is used so that its optical axis “L” is directed in a horizontal direction. Therefore, the “Z” direction corresponds to a front and rear direction in the horizontal direction, the “X” direction corresponds to a right and left direction in the horizontal direction, and the “Y” direction corresponds to an upper and lower direction.

(Schematic Structure of Imaging Device 100)

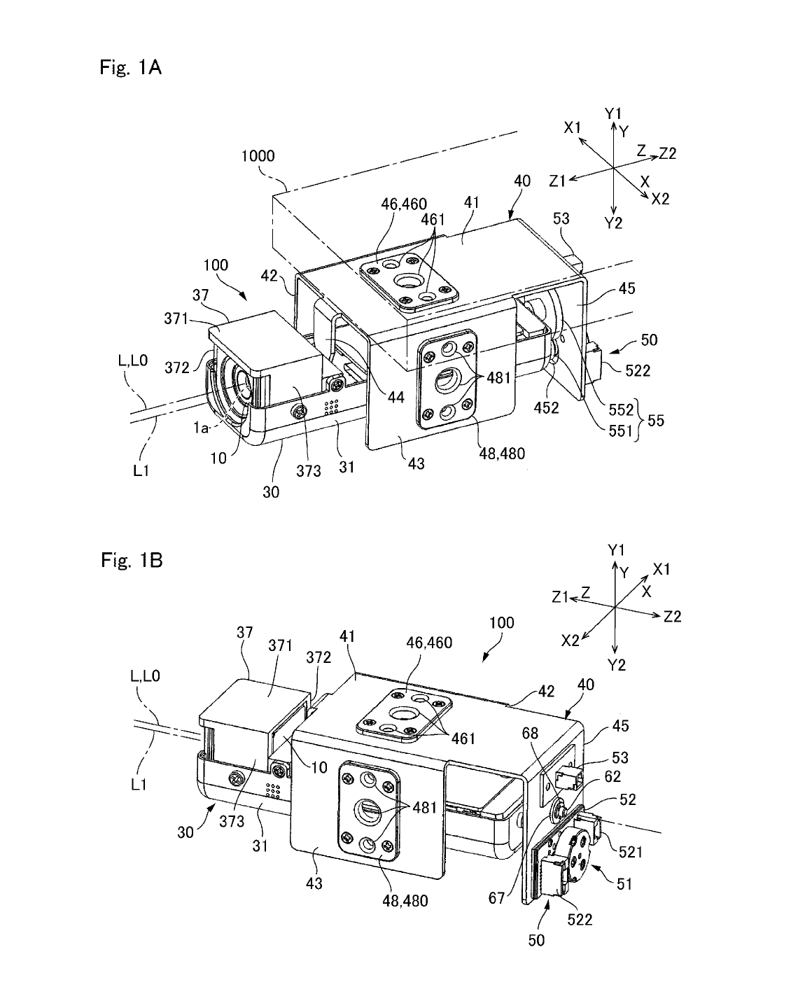

FIGS. 1A and 1B are perspective views showing an imaging device 100 to which at least an embodiment of the present invention is applied. FIG. 1A is a perspective view showing an imaging device 100 which is viewed from an object side (one side “Z1” in the “Z” direction), and FIG. 1B is a perspective view showing the imaging device 100 which is viewed from an opposite side (other side “Z2” in the “Z” direction) to an object side. FIG. 1A is an explanatory view schematically showing a state that the imaging device 100 is mounted on a moving body 1000 such as a vehicle.

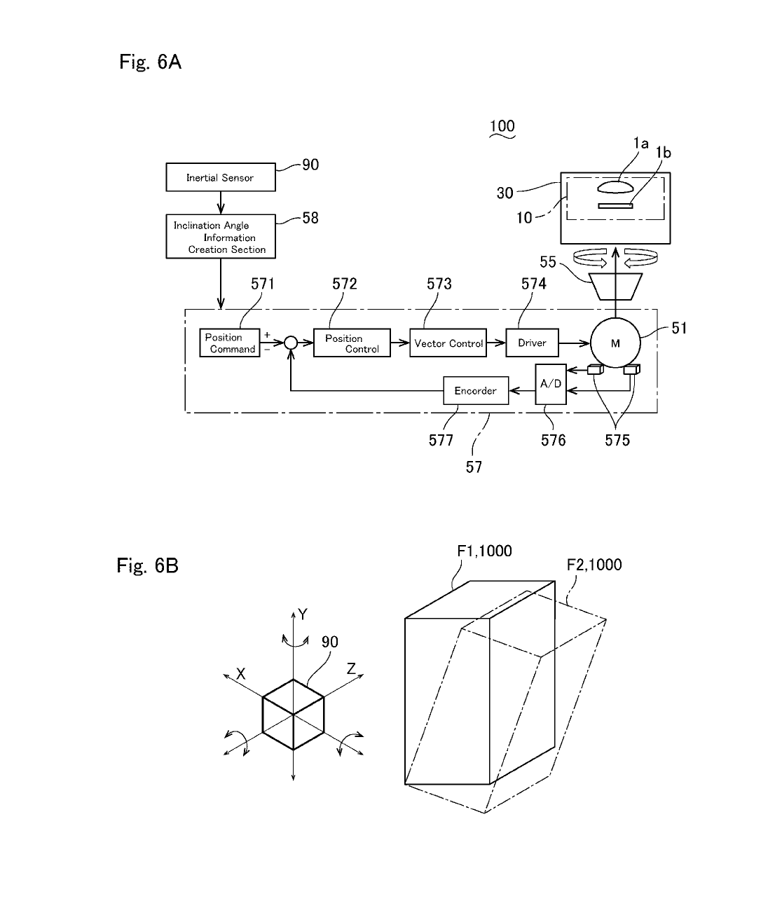

The imaging device 100 shown in FIGS. 1A and 1B includes an optical unit 10 for imaging which is provided with a lens 1a, an imaging element and the like. The imaging device 100 is mounted on the moving body 1000 such as a vehicle and captures images during traveling. In this case, when the moving body 1000 is inclined from a horizontal posture during traveling and the optical unit 10 is turned around the optical axis “L” and inclined, quality of a photographed image is deteriorated. Therefore, in the imaging device 100, an inertial sensor 90 described below with reference to FIGS. 6A and 6B is provided in a support body 40 of the imaging device 100 or the moving body 1000 and, based on a detected result (angular velocity or acceleration) of the inertial sensor 90, the optical unit 10 is turned around the optical axis “L” in the imaging device 100 to perform rolling correction for maintaining its horizontal posture.

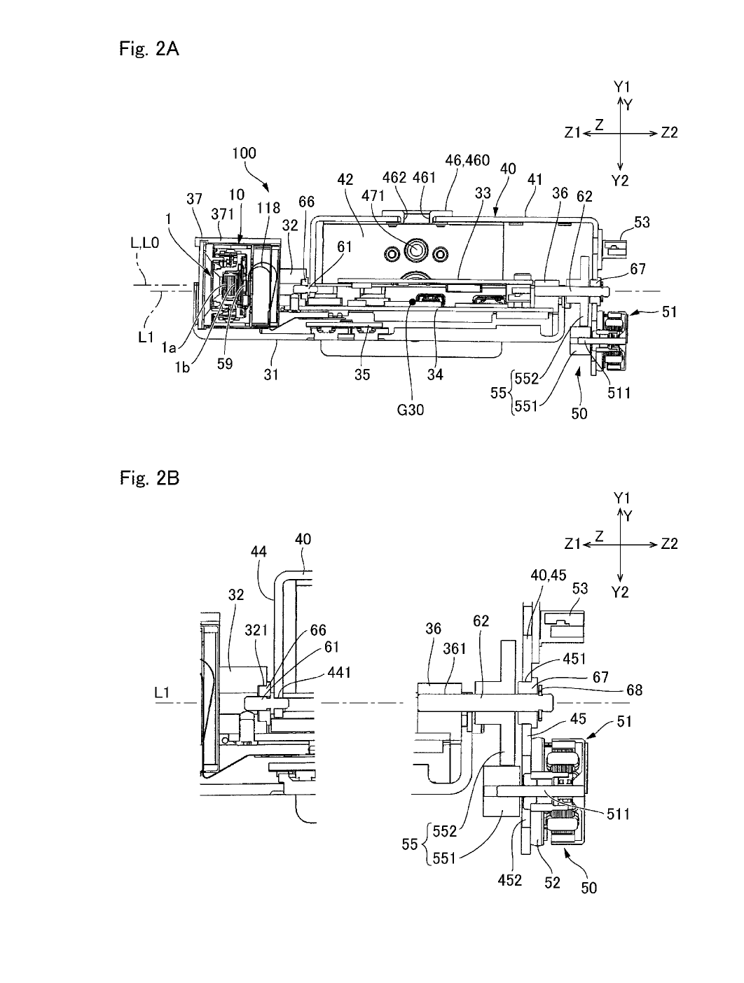

In addition, in the imaging device 100 in this embodiment, when the moving body 1000 is swung during traveling and the optical unit 10 is shaken around two axes perpendicular to the optical axis “L”, angular velocity is detected by a gyroscope 59 (see FIG. 2A) provided in the optical unit 10 to swing the photographing module 1 provided with the lens 1a, the imaging element 1b and the like (see FIG. 2A) around two axes perpendicular to the optical axis “L” and thereby pitching correction and yawing correction are performed.

(Entire Structure of Imaging Device 100)

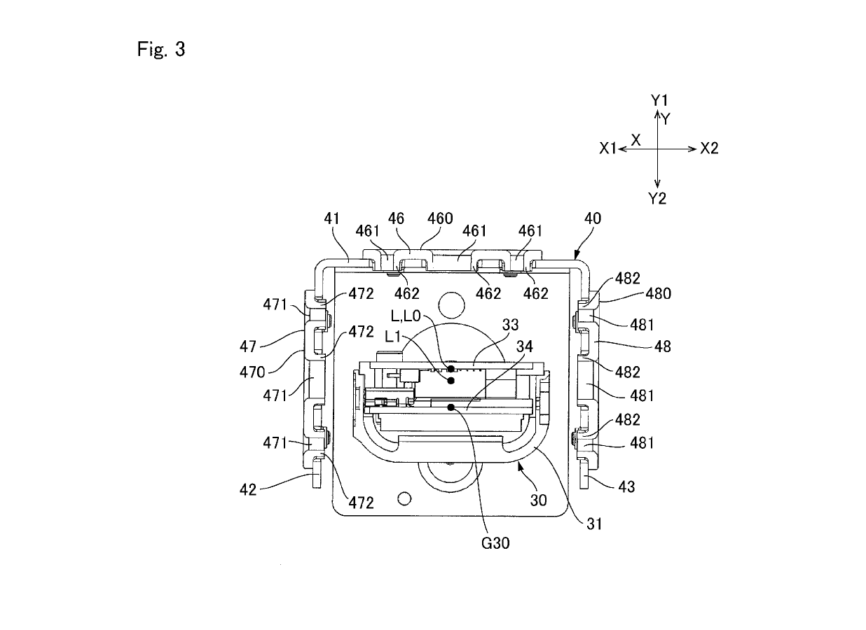

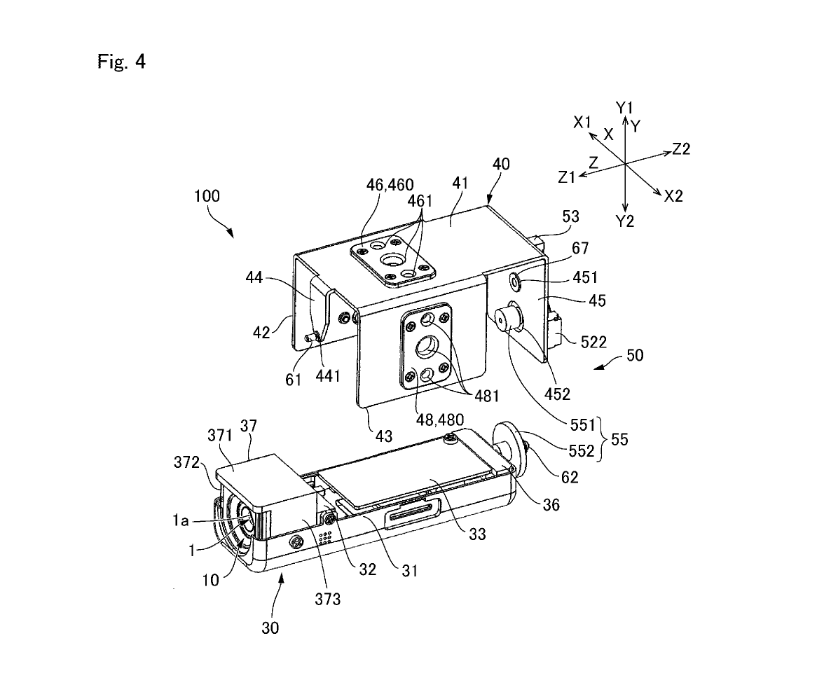

FIGS. 2A and 2B are “Y-Z” cross-sectional views showing the imaging device 100 to which at least an embodiment of the present invention is applied. FIG. 2A is a “Y-Z” cross-sectional view showing the entire imaging device 100 and FIG. 2B is an enlarged cross-sectional view showing turning support parts of the imaging device 100. FIG. 3 is an “X-Y” cross-sectional view showing the imaging device 100 to which at least an embodiment of the present invention is applied. FIG. 4 is an exploded perspective view showing the imaging device 100 to which at least an embodiment of the present invention is applied.

As shown in FIGS. 1A through 4, the imaging device 100 in this embodiment includes a movable body 30 provided with the optical unit 10 for imaging, and a support body 40 which turnably supports the movable body 30 around an axial line “L0” that is the same as the optical axis “L” (optical axis of the lens 1a) of the optical unit 10 or around an axial line “L1” parallel to the optical axis “L”. Further, the imaging device 100 includes a turning drive mechanism 50 structured to turn the movable body 30 around the axial line “L0” or around the axial line “L1”. In this embodiment, the support body 40 turnably supports the movable body 30 around the axial line “L1” parallel to the optical axis “L” of the optical unit 10, and the turning drive mechanism 50 turns the movable body 30 around the axial line “L1”. The axial line “L1” is extended so as to pass the lens 1a of the optical unit 10.

In this embodiment, the support body 40 surrounds the movable body 30 from three sides (in directions) perpendicular to the axial line “L1” through spaces therebetween. More specifically, the support body 40 is provided with a first plate part 41 extended in the “Z” direction on the “Yl” side, a second plate part 42 which is bent from an end part on one side “X1” in the “X” direction of the first plate part 41 to the other side “Y2” in the “Y” direction, and a third plate part 43 which is bent from an end part on the other side “X2” in the “X” direction of the first plate part 41 to the other side “Y2” in the “Y” direction. The first plate part 41 overlaps with the movable body 30 on one side “Yl” in the “Y” direction through a space, the second plate part 42 overlaps with the movable body 30 on one side “X1” in the “X” direction through a space, and the third plate part 43 overlaps with the movable body 30 on the other side “X2” in the “X” direction through a space.

An outer face of the first plate part 41 is fixed with a first fixing plate 46 by screws which is utilized as a first fixing face 460 when the support body 40 is fixed to the moving body 1000. An outer face of the second plate part 42 is fixed with a second fixing plate 47 by screws which is utilized as a second fixing face 470 when the support body 40 is fixed to the moving body 1000. An outer face of the third plate part 43 is fixed with a third fixing plate 48 by screws which is utilized as a third fixing face 480 when the support body 40 is fixed to moving body 1000. In this embodiment, all of the first fixing face 460 (first fixing plate 46), the second fixing face 470 (second fixing plate 47), and the third fixing face 480 (third fixing plate 48) are provided in the support body 40 in parallel with the axial line “L1” at the same position in the extending direction of the axial line “L1”.

As shown in FIGS. 1A and 1B and FIG. 3, three first fixing holes 461 are opened in the first fixing plate 46 side by side in the “X” direction. The first fixing hole 461 is formed of a tube part 462 which is protruded from the first fixing plate 46 toward the first plate part 41 and the tube part 462 is fitted into a hole formed in the first plate part 41. In the second fixing plate 47, three second fixing holes 471 are opened side by side in the “Y” direction. The second fixing hole 471 is formed of a tube part 472 which is protruded from the second fixing plate 47 toward the second plate part 42 and the tube part 472 is fitted into a hole formed in the second plate part 42. In the third fixing plate 48, three third fixing holes 481 are opened side by side in the “Y” direction. The third fixing hole 481 is formed of a tube part 482 which is protruded from the third fixing plate 48 toward the third plate part 43 and the tube part 482 is fitted into a hole formed in the third plate part 43. In this embodiment, all of the first fixing holes 461, the second fixing holes 471 and the third fixing holes 481 are provided in the support body 40 at the same position in the extending direction of the axial line “L1”.

As described above, the support body 40 is provided with a fixing face (first fixing face 460, second fixing face 470 and third fixing face 480) for fixing the support body 40 to the moving body 1000. Therefore, for example, as shown in FIG. 1A, the imaging device 100 can be fixed to the moving body 1000 through the first fixing plate 46 (first fixing face 460) provided in the first plate part 41 and, in this state, the optical axis “L” of the imaging device 100 is directed in the horizontal direction. In this case, when the imaging device 100 is to be fixed to the moving body 1000 through the first fixing plate 46 (first fixing face 460) provided in the first plate part 41, the first fixing holes 461 are utilized as a positioning hole or a hole for a screw.

As shown in FIGS. 1A and 1B, FIGS. 2A and 2B and FIG. 4, the support body 40 is provided with a fourth plate part 44, which is bent from an end part on one side “Z1” in the “Z” direction of the first plate part 41 toward the other side “Y2” in the “Y” direction, and a fifth plate part 45 which is bent from an end part on the other side “Z2” in the “Z” direction of the first plate part 41 toward the other side “Y2” in the “Y” direction. The fourth plate part 44 and the fifth plate part 45 are formed in a direction perpendicular to an extending direction of the axial line “L1”, in other words, toward a lower side with respect to the horizontal direction. The fourth plate part 44 is a first turning support plate part on the optical unit 10 side which is provided on one side end part in the extending direction of the axial line “L1” of the first plate part 41. The fifth plate part 45 is a second turning support plate part which is provided on the other side end part in the extending direction of the axial line “L1” of the first plate part 41 for turnably supporting an end part of the movable body 30 on the opposite side to the optical unit 10.

As shown in FIGS. 2B and 4, the fourth plate part 44 which is the first turning support plate part on the optical unit 10 side is formed with a hole 441 and a first shaft 61 is fixed to the hole 441 so as to protrude to one side “Z1” in the “Z” direction. A hole 451 is formed in the fifth plate part 45 which is the second turning support plate part for turnably supporting an end part of the movable body 30 on an opposite side to the optical unit 10 and a tube shaped bearing member 67 which turnably supports a second shaft 62 described below is fixed to the hole 451.

As shown in FIGS. 1A and 1B, FIGS. 2A and 2B and FIG. 4, a face on the other side “Z2” in the “Z” direction of the fifth plate part 45 is fixed with a motor 51 as a drive source of a turning drive mechanism 50, a motor circuit board 52 on which connectors 521 and 522 are mounted, a connector 53 and the like. In other words, the fifth plate part 45 is the second turning support plate part and, in addition, the fifth plate part 45 is a motor support plate part to which the motor 51 is fixed and supported. A rotation shaft 511 of the motor 51 is protruded to one side “Z1” in the “Z” direction from the fifth plate part 45 through a hole 452 penetrating through the fifth plate part 45. A portion of the rotation shaft 511 protruding to one side “Z1” in the “Z” direction from the fifth plate part 45 is fixed with a gear 551 which structures a deceleration mechanism 55 of the turning drive mechanism 50.

(Structure of Movable Body 30)

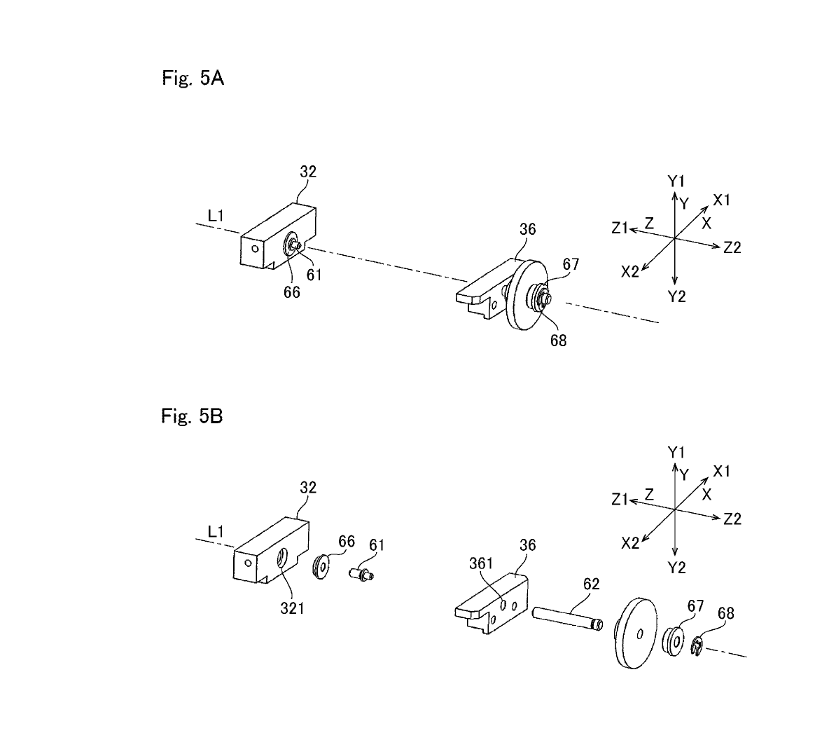

FIGS. 5A and 5B are explanatory views showing the turning support parts of the imaging device 100 to which at least an embodiment of the present invention is applied. FIG. 5A is an exploded perspective view showing the turning support part and FIG. 5B is an exploded perspective view showing the turning support part further disassembled.

As shown in FIGS. 1A and 1B, FIGS. 2A and 2B and FIG. 4, the movable body 30 includes a case 31 which is extended in a front and rear direction (“Z”-axis direction). The optical unit 10, a first holder 32, three circuit boards 33, 34 and 35 arranged so as to overlap with each other in the “Y” direction, and a second holder 36 are disposed and accommodated on an inner side of the case 31 in this order from one side “Z1” in the “Z”-axis direction toward the other side “Z2”.

The optical unit 10 is formed in a substantially rectangular parallelepiped shape and is fixed to the case 31 through a fixing plate 37. The fixing plate 37 is provided with an upper plate part 371 overlapped with an upper face of the optical unit 10 and a pair of side plate parts 372 and 373 which are extended to a lower side from both side end parts in the “X” direction of the upper plate part 371 and are overlapped with the side faces of the optical unit 10. The side plate parts 372 and 373 are fixed to the case 31 with screws.

In the movable body 30, the first holder 32 is fixed to the case 31 by a screw at a position adjacent to the optical unit 10 on the other side “Z2” in the “Z” direction. As shown in FIGS. 2B and 5B, a step-shaped hole 321 is opened on a face on the other side “Z2” in the “Z” direction of the first holder 32. A bearing member 66 in a tube shape which turnably supports the first shaft 61 is fixed to the hole 321. As a result, the first holder 32, in other words, the movable body 30 is turnably supported by the fourth plate part 44, which is the first turning support plate part of the support body 40, through the first shaft 61.

Three circuit boards 33, 34 and 35 are disposed in the movable body 30 so as to be overlapped in the “Y” direction at positions adjacent to the first holder 32 on the other side “Z2” in the “Z” direction. The circuit boards 33, 34 and 35 are electrically connected with the optical unit 10 and the motor 51 through a wiring member such as a flexible circuit board. Further, the circuit boards 33, 34 and 35 are structured with control circuits for performing rolling correction, pitching correction and yawing correction as described below and a power supply circuit. Further, the gyroscope 59 configured to detect an angular velocity when the swingable body 110 in an inside of the optical unit 10 is swung around two axes perpendicular to the optical axis “L” is provided in the optical unit 10, or one of the circuit boards 33, 34 and 35, or the flexible circuit board. In this embodiment, as an example, the gyroscope 59 is provided in the optical unit 10 (see FIG. 2A).

The second holder 36 is fixed to the movable body 30 by a screw at a position adjacent to the circuit boards 33 and 34 on the other side “Z2” in the “Z” direction. As shown in FIGS. 2B and 5B, a hole 361 is opened on a face on the other side “Z2” in the “Z” direction of the second holder 36, and the second shaft 62 is fixed to the hole 361. The second shaft 62 is turnably supported by the bearing member 67 which is fixed to the fifth plate part 45 of the support body 40. Therefore, the fifth plate part 45 is the second turning support plate part which turnably supports the second holder 36, in other words, the movable body 30. A snap ring 68 is fitted to the second shaft 62 at a position adjacent to the bearing member 67 on the other side “Z2” in the “Z” direction.

A gear 552 for turning the movable body 30 is fixed to the second shaft 62 and the gear 552 is engaged with a gear 551 fixed to the rotation shaft 511 of the motor 51. The movable body 30 and the second holder 36 are fixed to each other, and the second shaft 62 is fixed to the second holder 36, and the gear 552 is fixed to the second shaft 62. Therefore, when the gear 552 is turned by the gear 551 fixed to the rotation shaft 511 of the motor 51, the movable body 30 is also turned through the second holder 36. In this embodiment, the gear 552 has a larger diameter than the gear 551, and the gears 551 and 552 structure a deceleration mechanism 55 in the turning drive mechanism 50.

The first shaft 61 and the second shaft 62 are located on the axial line coaxial with the optical axis “L” or on the axial line “L1” (in this embodiment) which is parallel to the optical axis “L”. The optical axis “L” of the lens 1a of the optical unit 10 is located at a center in a width direction (“X” direction) of the movable body 30 perpendicular to the extending direction of the axial line “L1”, and the first shaft 61 and the second shaft 62 are also disposed at the center positions in the width direction (“X” direction) of the movable body 30. Therefore, the support body 40 turnably supports the movable body 30 around the axial line “L1” through the first shaft 61 and the second shaft 62 at both side end parts in the “Z” direction and, at a non-operation time when the turning drive mechanism 50 is not operated, the movable body 30 is held in a horizontal state. Further, the first shaft 61 and the bearing member 66 structure a first turning support part which turnably supports the movable body 30 at an end part of the support body 40 on one side “Z1” in an extending direction of the axial line “L1”. The second shaft 62 and the bearing member 67 structure a second turning support part which turnably supports the movable body 30 at an end part of the support body 40 on the other side “Z2” in the extending direction of the axial line “L1”. Therefore, the turning drive mechanism 50 can turn the movable body 30 around the axial line “L1”. In this embodiment, the second shaft 62 is fixed to the second holder 36 and the gear 552 is fixed to the second shaft 62. However, it may be structured that the second shaft 62 is fixed to the fifth plate part 45 and the second holder 36 is turned by the gear 552.

(Entire Structure of Imaging Device 100)

In the imaging device 100 structured as described above, the first plate part 41, the second plate part 42 and the third plate part 43 of the support body 40 surround the movable body 30 from three sides. However, a space is secured between the first plate part 41 and the movable body 30, between the second plate part 42 and movable body 30, and between the third plate part 43 and the movable body 30. Therefore, the support body 40 does not disturb turning of the movable body 30 around the axial line “L1”. However, a turnable range of the movable body 30 around the axial line “L1” is restricted by an interference of the movable body 30 with the support body 40 when the movable body 30 is turned around the axial line “L1”. In this embodiment, a turnable range of the movable body 30 around the axial line “L1” is set to be not less than 30° with respect to both sides of one side and the other side around the axial line “L1” from a stopped state of the turning drive mechanism 50. In this embodiment, the turnable range is set to be 60° on each of both sides of one side and the other side around the axial line “L1”.

In the imaging device 100, the fixing face (first fixing face 460, second fixing face 470 and third fixing face 480) is located between the optical unit 10 and the motor 51 in the extending direction of the axial line “L1”. Further, the movable body 30 includes the circuit boards 33, 34 and 35 between the optical unit 10 and the motor 51 in the extending direction of the axial line “L1” and thus a dimension in the extending direction of the axial line “L1” of the movable body 30 is longer than its dimension in a direction perpendicular to the axial line “L1”.

As shown in FIG. 2A, the gravity center G30 of the movable body 30 is located at substantially a center position of the movable body 30 in the extending direction of the axial line “L1”. Therefore, the gravity center G30 of the movable body 30 is located at a position overlapped with the fixing face (first fixing face 460, second fixing face 470 and third fixing face 480) in the extending direction of the axial line “L1”. In other words, the gravity center G30 of the movable body 30 is located at the same position as the fixing face (first fixing face 460, second fixing face 470 and third fixing face 480) in the extending direction of the axial line “L1”. Therefore, when viewed in the “Y” direction, the gravity center G30 of the movable body 30 is overlapped with the first fixing face 460 and, when viewed in the “X” direction, the gravity center G30 of the movable body 30 is overlapped with the second fixing face 470 and the third fixing face 480. In other words, the first fixing face 460 is located just above the gravity center G30 of the movable body 30 and the second fixing face 470 and the third fixing face 480 are located on both sides of the gravity center G30.

In this embodiment, the gravity center G30 of the movable body 30 is located between the circuit board 33 and the circuit board 34 in the “Y” direction (upper and lower direction). Therefore, as shown in FIG. 3, the gravity center G30 of the movable body 30 is located on a lower side in a gravity direction with respect to the axial line “L1” in the “Y” direction (upper and lower direction).

(Structure of Control System)

FIGS. 6A and 6B are explanatory views showing a control system for rolling correction in the imaging device 100 to which at least an embodiment of the present invention is applied. FIG. 6A is an explanatory view showing the entire control system and FIG. 6B is an explanatory view showing an inertial sensor 90. As shown in FIG. 6A, the imaging device 100 in this embodiment includes an inertial sensor 90 and a control system. When the imaging device 100 is inclined due to inclination of the moving body 1000, the inertial sensor 90 detects its angular velocity or acceleration, and an inclination angle information creation section 58 creates inclination angle information based on a detected result by the inertial sensor 90. More specifically, the inclination angle information creation section 58 integrates angular velocity and acceleration data detected by the inertial sensor 90 to create inclination angle information. In other words, as shown in FIG. 6B, when the moving body 1000 is inclined from a posture “F1” as shown by the solid line to a posture “F2” as shown by the alternate long and short dash line, the inertial sensor 90 detects angular velocity around the “X”-axis (an axial line extending in the “X” direction), angular velocity around the “Y”-axis (an axial line extending in the “Y” direction), angular velocity around the “Z”-axis (an axial line extending in the “Z” direction), acceleration in the “X” direction, acceleration in the “Y” direction and acceleration in the “Z” direction. Therefore, the inertial sensor 90 is capable of detecting angular velocity when the moving body 1000 is inclined due to inclination of the moving body 1000 and acceleration applied to the moving body 1000 when the moving body 1000 is inclined. Therefore, according to this embodiment, as shown in FIG. 6A, both of inclination of the moving body 1000 containing no acceleration and inclination of the moving body 1000 due to acceleration can be corrected by the control system.

In this embodiment, in order to perform the above-mentioned correction, the imaging device 100 is structured of a motor circuit 57 including the motor 51. In the motor circuit 57, first, a position command 571 is outputted based on inclination angle information. In this embodiment, based on the position command 571, position control 572 and vector control 573 are performed and driver 574 drives the motor 51. As a result, rotation of the motor 51 is transmitted to the movable body 30 through the deceleration mechanism 55 and thereby the movable body 30 (optical unit 10) is driven around the axial line “L1” in a direction eliminating the inclination.

In this case, rotation of the motor 51 is monitored by Hall elements 575, and a detected result of the Hall elements 575 is fed back through an A/D converter 576 and an encoder 577, and the inclination of the movable body 30 (optical unit 10) around the optical axis “L” is eliminated.

(Structure of Optical Unit 10)

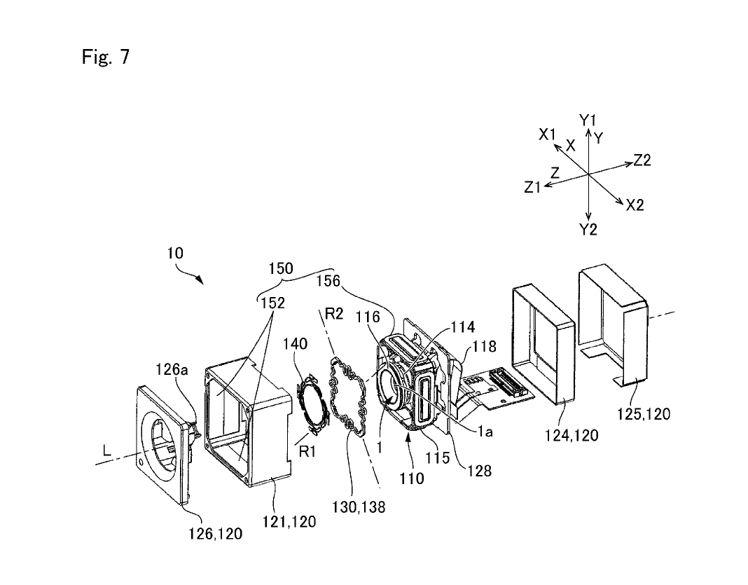

FIG. 7 is an exploded perspective view showing the optical unit 10 of the imaging device 100 to which at least an embodiment of the present invention is applied. As shown in FIG. 7, the optical unit 10 includes a unit case 120 including a tube-shaped case 121, the swing body 110 having a photographing module 1, a gimbal mechanism 130 as a support mechanism structured to swingably support the swing body 110 with respect to the unit case 120, and a swing drive mechanism 150 structured between the swing body 110 and the unit case 120. The swing drive mechanism 150 swings the swing body 110 around two axial lines (first axial line “Rl” and second axial line “R2”) perpendicular to the optical axis “L”.

The unit case 120 includes a cover 126 fixed to an end part on one side “Zl” in the “Z” direction of the tube-shaped case 121, a first bottom plate 124 disposed on the other side “Z2” in the “Z” direction of the tube-shaped case 121, and a second bottom plate 125 disposed on the other side “Z2” in the “Z” direction with respect to the first bottom plate 124. The second bottom plate 125 is fixed to the tube-shaped case 121 in a state that the first bottom plate 124 is held on its inner side. In this case, a plate-shaped stopper 128 in a rectangular frame shape is disposed between the tube-shaped case 121 and the second bottom plate 125 so as to surround the swing body 110. The plate-shaped stopper 128 restricts a movable range of the swing body 110 to the other side “Z2” in the “Z” direction.

The swing body 110 includes the photographing module 1 provided with optical elements such as the lens 1a and the imaging element 1b (see FIG. 2A), and the photographing module 1 is held by a frame 115. In the photographing module 1, the lens 1a is held by a lens holder 114. A weight 116 is fixed to the lens holder 114. The weight 116 adjusts a gravity center position in the extending direction of the optical axis “L” of the swing body 110. A coil 156 is held at both side end parts in the “X” direction and both side end parts in the “Y” direction of the frame 115. The swing body 110 is connected with a flexible circuit board 118 for outputting a signal obtained by the imaging element 1b and the like. A portion of the flexible circuit board 118 overlapping with the lens holder 114 is mounted with the gyroscope 59 (see FIG. 2A).

The swing drive mechanism 150 is a magnetic drive mechanism which utilizes plate-shaped magnets 152 and the coils 156. The coils 156 are held by the swing body 110. The magnets 152 are held on inner faces on both sides in the “X” direction of the tube-shaped case 121 and its inner faces on both sides in the “Y” direction. The magnet 152 faces the coil 156.

In the optical unit 10, in order to correct shakes in a pitching direction and a yawing direction, the swing body 110 is required to be swingably supported around a first axial line “R1” intersecting the optical axis “L” direction and, in addition, the swing body 110 is required to be swingably supported around a second axial line “R2” intersecting the optical axis “L” direction and the first axial line “R1”. Therefore, a gimbal mechanism 130 (support mechanism) is structured between the swing body 110 and the unit case 120. In this embodiment, in order to structure the gimbal mechanism 130, a movable frame 138 formed in a rectangular frame shape is used. In four corners of the movable frame 138, two corner parts located at diagonal positions in an extending direction of the first axial line “R1” are swingably supported by protruded parts 126a of the cover 126 through spherical bodies (not shown), and two corner parts located at diagonal positions in an extending direction of the second axial line “R2” swingably support a frame 115 of the swing body 110 through spherical bodies (not shown). A plate-shaped spring 140 which determines a posture of the swing body 110 when the swing drive mechanism 150 is set in a stopped state is provided between the swing body 110 and the cover 126. The plate-shaped spring 140 is a spring member of a metal plate processed in a predetermined shape and is connected with the swing body 110 and the cover 126.

(Pitching Correction and Yawing Correction)

In the optical unit 10, when the swing body 110 is shaken in a pitching direction and a yawing direction interlocked with movement of the moving body 1000, the shake is detected by the gyroscope 59 (see FIG. 2A) and, based on the detected result, the swing drive mechanism 150 is controlled. In other words, a drive current for canceling the shake having been detected by the gyroscope 59 is supplied to the coils 156 and, as a result, the swing body 110 is swung in a direction opposite to the shake around the first axial line “R1” and is swung in a direction opposite to the shake around the second axial line “R2” to correct the shakes in the pitching direction and the yawing direction.

(Principal Effects in this Embodiment)

As described above, the imaging device 100 in this embodiment includes the movable body 30 having the optical unit 10 for imaging and the support body 40 which turnably supports the movable body 30 around the axial line “L1” parallel to the optical axis “L” of the optical unit 10. The support body 40 is provided with the fixing face (first fixing face 460, second fixing face 470 and third fixing face 480) for fixing the support body 40 to the moving body 1000 in a direction perpendicular to the axial line “L1”. Therefore, when the imaging device 100 is fixed to the moving body 1000 such as a vehicle through the fixing face (first fixing face 460, second fixing face 470 and third fixing face 480) of the support body 40, the optical unit 10 is supported by the moving body 1000 in a state that the optical axis “L” is directed to the horizontal direction.

In a case that the moving body 1000 is inclined so that the optical unit 10 is inclined around the optical axis “L”, the turning drive mechanism 50 turns the movable body 30 around the axial line “L1” based on a detected result of the inertial sensor 90 provided in the support body 40 of the imaging device 100 or the inertial sensor 90 provided in the moving body 1000 and thereby influence by the inclination of the movable body 1000 is corrected. Therefore, even in a case that the optical unit 10 is inclined around the optical axis “L” by receiving angular velocity or acceleration (centrifugal force) when the moving body 1000 is inclined, the inclination around the optical axis “L” of the optical unit 10 can be corrected.

The imaging device 100 is provided with the inertial sensor 90 configured to detect an inclination around the axial line “L1” of the movable body 30 in the support body 40. Therefore, an inclination around the axial line “L1” of the moving body 1000 when the moving body 1000 is inclined is detected by the imaging device 100 itself and the movable body is turned around the axial line “L1” by an amount of the inclination and thereby influence due to the inclination of the moving body can be corrected. Alternatively, the imaging device 100 detects an inclination around the axial line “L1” of the moving body 1000 when the moving body 1000 is inclined by a detected result of the inertial sensor 90 mounted on the moving body 1000 and the movable body is turned around the axial line “L1” by an amount of the inclination and thereby influence due to the inclination of the moving body can be corrected.

The fixing face (first fixing face 460, second fixing face 470 and third fixing face 480) of the support body 40 is located between the optical unit 10 and the motor 51 in an extending direction of the axial line “L1”. Therefore, the fixing face (first fixing face 460, second fixing face 470 and third fixing face 480) is located between the optical unit 10 and the drive source (motor 51) whose weights are relatively heavy. Accordingly, the imaging device 100 can be fixed to the moving body 1000 in a well-balanced manner and thus the imaging device 100 can be restrained from shaking by external force. Further, the gravity center G30 of the movable body 30 is located at a position overlapping with the fixing face (first fixing face 460, second fixing face 470 and third fixing face 480) in an extending direction of the axial line “L1”. Therefore, the imaging device 100 can be fixed to the movable body 1000 in a well-balanced manner and thus the imaging device 100 can be restrained from shaking by external force.

A dimension of the movable body 30 in an extending direction of the axial line “L1” is longer than its dimension in a direction perpendicular to the axial line “L1” and thus the size in a direction perpendicular to the optical axis “L” of the imaging device 100 can be reduced.

The first shaft 61 and the bearing member 66 (first turning support part) which turnably support the movable body 30 are provided at an one side end part of the support body 40 in an extending direction of the axial line “L1”, and the second shaft 62 and the bearing member 67 (second turning support part) which turnably support the movable body 30 are provided at the other side end part of the support body 40 in the extending direction of the axial line “L1”. Therefore, the support body 40 is capable of supporting the movable body 30 at two separated positions in the extending direction of the axial line “L1” in a stable state.

The gravity center G30 of the movable body 30 is located on a lower side in a gravity direction relative to the axial line “L1”. Therefore, when acceleration is not applied to the movable body 30, the movable body 30 is set in a hanged state in a vertical direction by the own weight of the movable body 30 and thus the optical unit 10 is set in a posture that its optical axis “L” is directed to the horizontal direction, in other words, the optical unit 10 is set in a horizontal state.

The axial line “L1” is extended so as to pass through the lens 1a of the optical unit 10. Therefore, a space for turning the movable body 30 for correcting an inclination around the optical axis “L” of the optical unit 10 can be reduced.

The turning drive mechanism 50 uses the motor 51 as a drive source and the motor 51 utilizes attraction force and repulsive force by a rotor magnet and thus, in comparison with a case that Lorentz force is utilized, large torque can be obtained.

(Other Embodiments)

In the embodiment described above, the gravity center G30 of the movable body 30 is located on a lower side in a gravity direction relative to the axial line “L1”. However, the gravity center G30 of the movable body 30 may be located on the axial line “L1”. According to this structure, even when acceleration in the horizontal direction (“X” direction) is applied to the imaging device 100, a shake is hard to be generated in the movable body 30.

In the embodiment described above, as an example, a vehicle is described as the moving body 1000. However, the moving body 1000 may be applied to a roller coaster or an unmanned aircraft other than a vehicle.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. An imaging device comprising:
a movable body comprising an optical unit;
a support body structured to turnably support the movable body around an axial line of an optical axis of the optical unit or around an axial line parallel to the optical axis; and
a turning drive mechanism structured to turn the movable body around the axial line;
wherein the support body comprises a fixing face for fixing the support body to a moving body in a direction perpendicular the axial line.

2. The imaging device according to claim 1, further comprising an inertial sensor configured to detect inclination around the axial line in the moving body,
wherein the turning drive mechanism is structured to turn the movable body around the axial line in response to a detected result of the inertial sensor.

3. The imaging device according to claim 2, wherein the inertial sensor is held by the support body.

4. The imaging device according to claim 2, wherein the inertial sensor is held by the moving body.

5. The imaging device according to claim 2, wherein the inertial sensor is structured to detect angular velocity when the movable body is inclined and acceleration applied to the movable body.

6. The imaging device according to claim 2, wherein a gravity center of the movable body is located to a lower side in a gravity direction of the axial line.

7. The imaging device according to claim 2, wherein a gravity center of the movable body is located at a same position in a gravity direction as the axial line.

8. The imaging device according to claim 2, wherein the axial line is extended so as to pass a lens of the optical unit.

9. The imaging device according to claim 8, wherein
the support body surrounds the movable body in three directions perpendicular to the axial line through a space, and
a turnable range around the axial line of the movable body is restricted by an interference of the movable body with the support body when the movable body is turned around the axial line.

10. The imaging device according to claim 1, wherein
a drive source of the turning drive mechanism is a motor, and
the fixing face is located between the optical unit and the motor in an extending direction of the axial line.

11. The imaging device according to claim 10, wherein
the movable body comprises a circuit board between the optical unit and the motor in the extending direction of the axial line, and
a dimension in the extending direction of the axial line of the movable body is longer than a dimension in a direction perpendicular the axial line.

12. The imaging device according to claim 10, wherein a gravity center of the movable body is located at a position overlapping with the fixing face in the extending direction of the axial line.

13. The imaging device according to claim 12, wherein the gravity center of the movable body is located to a lower side in a gravity direction of the axial line.

14. The imaging device according to claim 12, wherein the gravity center of the movable body is located at a same position in a gravity direction as the axial line.

15. The imaging device according to claim 10, wherein
the motor is held by the support body,
a first side end part in the extending direction of the axial line of the support body is provided with a first turning support part which turnably supports the movable body, and
a second side end part in the extending direction of the axial line of the support body is provided with a second turning support part which turnably supports the movable body.

16. The imaging device according to claim 15, wherein
the first side end part in the extending direction of the axial line of the support body is formed with a first turning support plate part formed in a direction perpendicular to the extending direction of the axial line,
the first turning support part is provided in the first turning support plate part,
the second side end part in the extending direction of the axial line of the support body is formed with a second turning support plate part formed in a direction perpendicular to the extending direction of the axial line, and
the second turning support part and the motor are held by the second turning support plate part.

17. The imaging device according to claim 16, wherein
the movable body comprises a case which accommodates the optical unit and the circuit board,
the movable body is turnably supported by the first turning support part provided in the first support plate part between the optical unit and the circuit board,
the circuit board is disposed between the first turning support part and the second turning support part,
the second turning support part is provided with a gear which is driven by the motor, and
the movable body is turned by the gear.

18. The imaging device according to claim 17, wherein the motor of the turning drive mechanism is structure to turn the movable body around the axial line in response to a detected result of an inertial sensor configured to detect inclination around the axial line in the movable body.

19. The imaging device according to claim 15, wherein
the support body surrounds the movable body in three directions perpendicular to the axial line through a space, and
a turnable range around the axial line of the movable body is restricted by an interference of the movable body with the support body when the movable body is turned around the axial line.

20. The imaging device according to claim 19, wherein the turnable range around the axial line of the movable body is set to be 30° or more to both sides around the axial line from a state that the turning drive mechanism is not driven.

21. The imaging device according to claim 10, further comprising an inertial sensor configured to detect inclination around the axial line of the movable body,
wherein the motor of the turning drive mechanism is structured to turn the movable body around the axial line in response to a detected result of the inertial sensor.

22. The imaging device according to claim 10, wherein the motor of the turning drive mechanism is structured the movable body around the axial line in response to a detected result of an inertial sensor configured to detect inclination around the axial line of the movable body.

23. The imaging device according to claim 1, wherein a gravity center of the movable body is located to a lower side in a gravity direction of the axial line.

24. The imaging device according to claim 1, wherein a gravity center of the movable body is located at a same position in a gravity direction as the axial line.

25. The imaging device according to claim 1, wherein the axial line is extended so as to pass a lens of the optical unit.

26. The imaging device according to claim 1, wherein the support body surrounds the movable body in three directions perpendicular to the axial line through a space, and a turnable range around the axial line of the movable body is restricted by an interference of the movable body with the support body when the movable body is turned around the axial line.

27. The imaging device according to claim 1, wherein a turnable range around the axial line of the movable body is set to be 30° or more to both sides around the axial line from a state that the turning drive mechanism is stopped.

28. The imaging device according to claim 1, wherein the optical unit comprises a photographing module comprising a lens and an imaging element, and a swing drive mechanism structured to swing the photographing module around two axial lines intersecting the optical axis.
